(19) United States
(12) Patent Application Publication
(10) Pub. No.: US 2013/0327972 A1
(43) Pub. Date: Dec. 12, 2013

(54) ARRANGEMENT OF A VALVE IN A BORE OF A DUCT HOUSING

(71) Applicants: Michael Quirll, Koeln (DE); Dirk Bornemann, Duesseldorf (DE)

(72) Inventors: Michael Quirll, Koeln (DE); Dirk Bornemann, Duesseldorf (DE)

(73) Assignee: PIERBURG GMBH, NEUSS (DE)

(21) Appl. No.: 13/640,740

(22) PCT Filed: Mar. 23, 2011
(86) PCT No.: PCT/EP11/54425

§ 371 Date: Oct. 12, 2012

(30) Foreign Application Priority Data
Apr. 13, 2010 (DE) 10 2010 014841.5

(51) Int. Cl. F16K 1/44

(52) U.S. Cl. CPC F16K 1/44
USPC 251/324

(57) ABSTRACT

An arrangement of a valve in a bore of a duct housing includes the duct housing comprising the bore with a stepped design. A valve housing with a stepped outer diameter comprises an inlet and at least one outlet, and is plugged into the bore of the duct housing. A translational valve rod is arranged in the valve housing. At least one valve-closure member is arranged on the translational valve rod. The at least one valve-closure member corresponds with at least one valve seat. A bore diameter of the bore decreases when viewed from a plug-in direction of the valve housing. The stepped outer diameter forms an interference fit with the bore diameter in regions radially surrounding the at least one valve seat. Other regions of the stepped outer diameter have an outer diameter which is smaller than the respective radially surrounding bore diameter.

### CROSS REFERENCE TO PRIOR APPLICATIONS

This application is a U.S. National Phase application under 35 U.S.C. §371 of International Application No. PCT/EP2011/054425, filed on Mar. 23, 2011 and which claims benefit to German Patent Application No. 10 2010 014 841.5, filed on Apr. 13, 2010. The International Application was published in German on Oct. 20, 2011 as WO 2011/128191 A1 under PCT Article 21(2).

### FIELD

The present invention relates to an arrangement of a valve in a bore of a duct housing comprising a valve housing formed with an inlet and at least one outlet, and which is plugged into the bore of the duct housing, wherein a translational valve rod is arranged in the valve housing, on which rod at least one valve-closure member corresponding with a valve seat is arranged.

### BACKGROUND

Such valves are used, for instance, in internal combustion engines as exhaust gas recirculation valves in exhaust gas recirculation ducts. The design as a plug-in valve with a housing that already forms parts of one or a plurality of ducts is advantageous in that such a valve can be completely preassembled and shipped, and can thereafter be mounted into the duct housing. This type of valve is plugged into the duct housing from an open side of a bore in the duct housing and is fastened to the duct housing by means such as screws. Care must be taken, however, that no exhaust gas escapes to the outside, i.e., that no leaks exist that could result in environmental pollution.

DE 103 332 915 A1 describes an exhaust gas recirculation valve configured as a plug-in valve, the plug-in valve comprising an exhaust gas inlet and two exhaust gas outlets. The connection between the inlet and the outlet can be controlled through two valve members arranged on a common actuator rod by lowering the valve members onto a valve seat or by lifting them therefrom. The inlet is arranged between the two valve seats and thus also between the two exhaust gas outlets. The valve is arranged in a bore of the surrounding duct housing. The valve housing and the duct housing each have a continuous uniform diameter. These two diameters are normally designed as continuous interference fits, whereby sufficient tightness to the outside and between the channels is normally ensured. With such an arrangement, however, problems occur when the valve housing is mounted and dismounted. In particular, after repeated mounting and dismounting, scores are formed in the housing walls facing each other, resulting in increased leakage.

DE 102 13 693 A1 describes an alternative system for sealing a plug-in valve in a surrounding housing. In this valve, the outer diameter of the plug-in valve is slightly smaller than the bore diameter of the duct housing, the duct housing and the valve housing comprising a corresponding shoulder forming a support surface. Bead gaskets are placed respectively on this support surface and at the fastening surface of the plug-in valve at the outer wall of the duct housing, which bead gaskets are clamped between both housing parts and thereby result in a radial sealing. With a valve having a plurality of outlets, however, further shoulders and seals would be required. The seals cannot, however, be preassembled, so that the supplier of the valve cannot ensure a correct and tight installation in the housing.

### SUMMARY

An aspect of the present invention is to provide an arrangement of a valve in a bore of a duct housing which provides a sufficient sealing effect between the housings without additional sealing elements, while still allowing for repeated mounting and dismounting without the unacceptably increasing leakage.

In an embodiment, the present invention provides an arrangement of a valve in a bore of a duct housing which includes the duct housing comprising the bore with a stepped design. A valve housing with a stepped outer diameter comprises an inlet and at least one outlet. The valve housing is configured to be plugged into the bore of the duct housing. A translational valve rod is arranged in the valve housing. At least one valve-closure member is arranged on the translational valve rod. The at least one valve-closure member is configured to correspond with at least one valve seat. A bore diameter of the bore decreases when viewed from a plug-in direction of the valve housing. The stepped outer diameter of the valve housing is configured to form an interference fit with the bore diameter in regions radially surrounding the at least one valve seat. Other regions of the stepped outer diameter of the valve housing have an outer diameter which is smaller than the respective radially surrounding bore diameter.

### BRIEF DESCRIPTION OF THE DRAWINGS

The present invention is described in greater detail below on the basis of embodiments and of the drawing in which:

FIG. 1 shows a sectional side elevational view of a detail of a valve in a bore of a duct housing.

### DETAILED DESCRIPTION

A good seal is obtained by the bore having a stepped design, wherein the bore diameter decreases in the plug-in direction of the valve housing and the outer diameter of the valve housing is stepped, such that an interference fit for the respective bore diameter is formed in the regions surrounding the at least one valve seat, while the other regions have an outer diameter that is smaller than the radially surrounding bore diameter. At the same time, such a valve can be mounted with little effort since the surfaces, along which the two housings slide relative to each other, are considerably reduced. The mechanical stress on the two surfaces sliding along each other decreases accordingly, so that abrasion occurring during repeated mounting and dismounting is considerably reduced and thus largely constant leakage rates are achieved.

In an embodiment of the present invention, the valve can, for example, comprise two valve-closure members on a valve rod by which it is possible to control two flow cross sections surrounded by valve seats, the flow cross sections leading to two outlets in the valve housing, while the inlet is arranged between the two outlets. With such a valve, a balance of forces exists at the valve in any operational state due to the two oppositely loaded valve-closure members which are actuated synchronously. This allows for a more precise control and the use of a smaller drive for the valve.

In an embodiment of the present invention, both regions of the valve housing surrounding the valve seats can, for example, have an outer diameter that substantially corresponds to the associated bore diameter of the duct housing. The sealing between the two housings is thus achieved with these contact surfaces. At the same time, the sealing is reasonably restricted to the regions around the inlet where sealing is relevant, and thus around the region where higher pressure prevails. Both a sealing to the environment and a sealing with respect to the outlets is provided.

In an embodiment of the present invention, the duct housing can, for example, have three different bore diameters, two of which correspond with the two regions surrounding the valve seats, which are arranged axially on both sides of the inlet. This embodiment makes it possible to simply plug the valve into the bore since the two interference fits are formed with different diameters and thereby a contact between the housings is given only in the last part of the insertion path.

In an embodiment of the present invention, the bore shoulders can, for example, each be formed immediately in front of the corresponding interference fits, as seen in the plug-in direction of the valve housing. This reduces the axial length of contact to a minimum when plugging in the valve so that the wear of the surfaces during mounting and dismounting is considerably reduced.

In an embodiment of the present invention, the leading end of the valve housing, as seen in the plug-in direction, can be chamfered or curved. A guiding is thereby achieved when the valve is plugged in and a jamming, due to canting during assembly, is prevented.

In an embodiment of the present invention, the valve housing can, for example, have a region between the two valve seats where the outer diameter of the valve housing is smaller than the surrounding bore diameter. One of the steps of the housing bore is also situated in this region. This also results in shortened sliding surfaces and to an insensitivity with respect to axial tolerances to be maintained.

The valve housing also has a region which can, for example, be situated between the plug-in opening of the duct housing and the valve seat closer to the plug-in opening, where the outer diameter of the valve housing is smaller than the surrounding bore diameter. This region also includes a step of the housing bore. This also results in shortened sliding surfaces when the valve is mounted and dismounted.

An arrangement of a valve in a bore of a duct housing is thus provided by which the wear of the sliding surfaces or the valve housing, which occurs during mounting and dismounting, is considerably reduced. A reliable sealing is accordingly achieved, while the effort for mounting and dismounting the valve is reduced. Leakages are thus reliable avoided even with repeated mounting and dismounting.

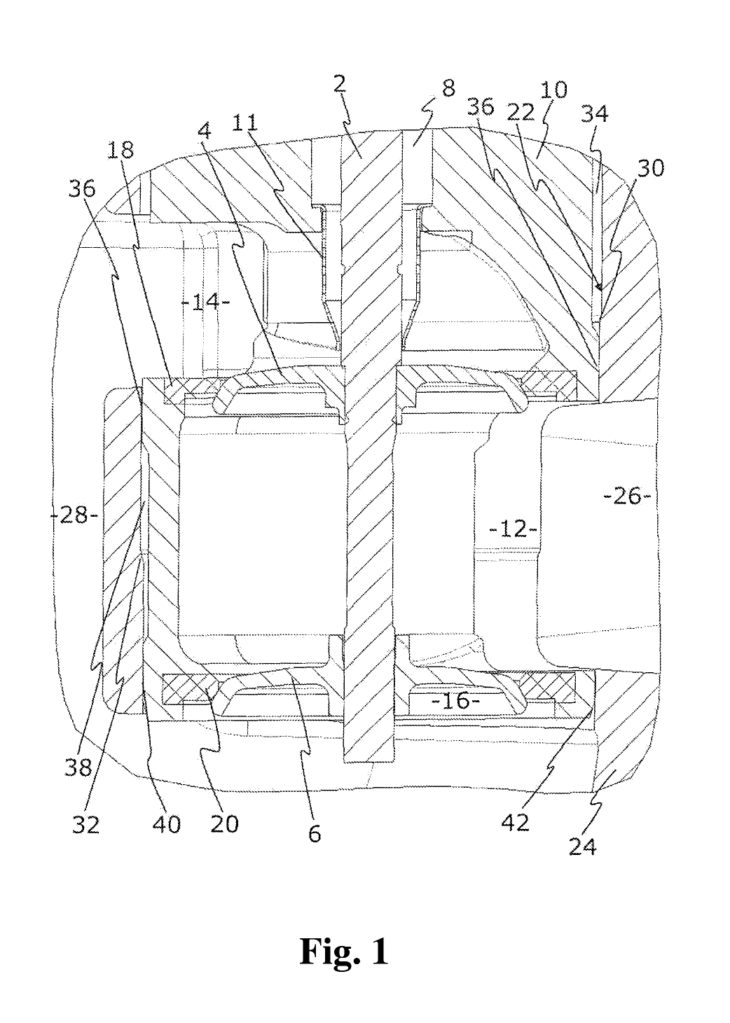

An embodiment of the arrangement according to the present invention is described hereinafter with reference to an exhaust gas recirculation valve in a bore of a duct housing of an exhaust gas recirculation duct as illustrated in FIG. 1.

The valve illustrated is formed by a translational valve rod 2 movable by means of a non-illustrated actuator, on which valve rod two valve-closure members 4, 6 are fastened at least axially. The valve rod 2 is guided axially in a slide bush 8 that is supported in a valve housing 10. The region of the valve rod 2 adjoining the slide bush is surrounded by a protective sheet 11 that largely prevents the intrusion of gas into the slide bush 8.

The valve housing 10 comprises a radial inlet 12 as well as a radial outlet 14 and an axial outlet 16, the inlet 12 being arranged axially between the two outlets 14, 16. A controllable flow cross section exists between the inlet 12 and the outlets 14, 16, respectively, wherein each flow cross section is surrounded by a respective valve seat 18, 20 which in turn cooperates with one of the valve-closure members 4, 6 such that, upon a movement of the valve rod 2, and thus of the valve-closure members 4, 6, the two flow cross sections are reduced by a synchronous lowering of the valve-closure members 4, 6 towards the valve seats 18, 20, or the flow cross sections are enlarged by a synchronous lifting of the members from the valve seats 18, 20. In a manner known per se, it is hereby possible to change the volume of a gas flow to be controlled.

The valve housing 10 is arranged in a bore 22 of a duct housing 24, it being important to avoid leakages between the two housings 10, 24. The duct housing 24 has a first, upstream duct section 26 corresponding with the inlet 12 of the valve housing 10, as well as a second, downstream duct section 28 in communication with the outlets 14, 16.

The bore 22 has a first bore shoulder 30, as well as a second bore shoulder 32, where the bore diameter respectively decreases in a step-like manner in the plug-in direction of the valve, seen from the plug-in opening. The plug-in direction corresponds to the direction in which the valve-closure members move to clear the flow cross sections. The valve is accordingly plugged into the bore 22 in the direction of the axial outlet 16 from the non-illustrated plug-in opening of the duct housing 24.

The valve housing comprises five axially successive regions differing in outer diameter. When mounted, a first region 34, seen in the plug-in direction of the valve, has an outer diameter that is smaller than the bore diameter radially surrounding this first region 34, so that no contact exists between the walls. Radially outside this first region 34, the first bore shoulder 30 is also provided which is situated in immediate proximity to a second region 36 adjoining the first region 34, the second region 36 having a greater outer diameter than the first region 34. This second region 36 has an interference fit with respect to the bore 22 and extends axially to both sides with respect to the valve seat 18.

A third region 38 adjoining the second region 36 again has a smaller outer diameter that is also smaller than the smallest bore diameter on the other side of the second bore shoulder 32 and also extends beyond the same, with a gap existing between the housings 10, 24.

A fourth region 40 of the valve housing 10, which in turn adjoins the third region 38 in the axial direction, has substantially the same outer diameter as the surrounding bore 22. The diameter of the fourth region 40 is, however, smaller than that of the second region 36, since it is arranged beyond the bore shoulder 32 and therefore has an interference fit with the smallest bore diameter. This fourth region 40 in turn surrounds the valve seat 20 so that the inlet 12 is surrounded on both axial sides by the interference fits. Adjoining this is a fifth region in the form of a chamfer 42 tapering towards the outlet 16.

It is a result of these shapes that, due to the chamfer 42, the valve housing 10 can first be inserted into the bore in a simple manner. During the plugging, a first resistance occurs only when the fourth region 40 is pushed over the shoulder 32 of the bore 22. This fourth region 40 then slides along the surrounding bore wall. A second interference fit is reached only when the second region 36 is also pushed over the bore shoulder 30. However, the fitting lengths or the sliding surface lengths are considerably shortened by this embodiment. The sealing is obtained by the interference fit between the bore diameter and the second region 36 or the fourth region 40 of the valve housing 10, respectively. The fourth region 40 here prevents a leakage from the inlet 12 to the axial outlet 16, whereas the second region 36 prevents a leakage flow from the inlet 12 to the radial outlet 14. Depending on pressure conditions, a sealing from the radial outlet 14 to the environment is not required or may be effected through the fastening of the plug-in valve on the housing. A further shoulder of the housing as defined by the present invention can also be formed.

An arrangement of a valve in a bore of a housing is accordingly provided, wherein a reliable sealing is provided even with repeated mounting and dismounting, since a wear of the mutually sealing fitting surfaces is largely avoided by a drastic shortening of the fitting surfaces. A reliable sealing is still provided without the need for additional seals.

Various structural modifications are conceivable that can be made to the aforementioned embodiment and still fall within the scope of protection of the application. In particular, the steps and diameters have to be adapted to the respective valve to be installed. The lengths of the fitting surfaces must also be adapted to pressure conditions.

The present invention is not limited to embodiments described herein; reference should be had to the appended claims.

What is claimed is:

1-8. (canceled)

9. An arrangement of a valve in a bore of a duct housing, the arrangement comprising:
the duct housing comprising the bore with a stepped design;
a valve housing with a stepped outer diameter, the valve housing comprising an inlet and at least one outlet, the valve housing being configured to be plugged into the bore of the duct housing;
a translational valve rod arranged in the valve housing; and
at least one valve-closure member arranged on the translational valve rod, the at least one valve-closure member being configured to correspond with at least one valve seat;
wherein,
a bore diameter of the bore decreases when viewed from a plug-in direction of the valve housing,
the stepped outer diameter of the valve housing is configured to form an interference fit with the bore diameter in regions radially surrounding the at least one valve seat, and
other regions of the stepped outer diameter of the valve housing have an outer diameter which is smaller than the respective radially surrounding bore diameter.

10. The arrangement as recited in claim 9, wherein two valve-closure members are arranged on the translational valve rod, the at least one valve seat includes two valve seats, and the valve housing comprises two outlets, wherein the two valve closure members are each configured to control a respective flow cross section surrounded by a respective valve seat, each of the flow cross sections lead to a respective outlet, and the inlet is arranged between the two outlets.

11. The arrangement as recited in claim 10, wherein the stepped outer diameter of the valve housing configured to form an interference fit with the bore diameter in the regions surrounding the two valve seats have an outer diameter that substantially corresponds to the corresponding bore diameter of the duct housing.

12. The arrangement as recited in claim 10, wherein the duct housing further comprises three different bore diameters, wherein two of the three different bore diameters correspond with the regions surrounding the two valve seats and are arranged axially on each side of the inlet.

13. The arrangement as recited in claim 12, further comprising bore shoulders, wherein each bore shoulder is formed directly in front of the interference fit when viewed from the plug-in direction of the valve housing.

14. The arrangement as recited in claim 10, wherein one of the other regions of the valve housing is arranged between the two valve seats, the one of the other regions having an outer diameter which is smaller than the radially surrounding bore diameter.

15. The arrangement as recited in claim 9, wherein the valve housing further comprises a leading end which is chamfered or curved when viewed from the plug-in direction of the valve housing.

16. The arrangement as recited in claim 9, wherein the duct housing further comprises a plug-in opening, and wherein one of the other regions of the valve housing is arranged between the plug-in opening and the at least one valve seat arranged closer to the plug-in opening, the outer diameter of the valve housing being smaller than the radially surrounding bore diameter.
